(19) United States
(12) Patent Application Publication
(10) Pub. No.: US 2021/0102393 A1
(43) Pub. Date: Apr. 8, 2021

(54) FLOAT FEEDER DEVICE FOR REGULATING THE FLOW OF CONCENTRATED CHLORINATED WATER FROM A CHLORINE GENERATOR

(71) Applicant: Daniel Moroni Tucker, Brentwood, CA (US)

(72) Inventor: Daniel Moroni Tucker, Brentwood, CA (US)

(21) Appl. No.: 16/660,797

(22) Filed: Oct. 22, 2019

Related U.S. Application Data
(60) Provisional application No. 62/748,642, filed on Oct. 22, 2018.

(51) Int. Cl. E04H 4/12; F16L 55/11

(52) U.S. Cl. CPC E04H 4/1281; E04H 4/1209; F16L 55/1108

(57) ABSTRACT

A float feeder device helps make a Chlorine Generator Unit easier to install, and prevents a pool filter pump from drawing air and losing its prime while the suction created by the pump draws concentrated chlorinated water. The device regulates the flow of concentrated chlorinated water from a chlorine generator to water to be treated. The device includes: a float housing and a float assembly that moves up and down within the housing. The float assembly has a float with an elongated stopper member that projects downward and has a conical stopper end. An output port allows concentrated chlorinated water out from the bottom end of the housing. A rubber O-ring at the output port permits flow of concentrated chlorinated water only through the rubber O-ring, and receives the conical stopper end to form a fluid-tight and air-tight seal whenever the conical stopper end is seated on the rubber O-ring.

### CROSS-REFERENCES TO RELATED APPLICATIONS

This application claims priority from Provisional Patent Application No. 62/748,642, filed Oct. 22, 2018, the entire contents of which is herein incorporated by reference.

### FIELD OF THE INVENTION

This invention relates generally to chlorine generators, and particularly to systems for regulating the flow of concentrated chlorinated water from the brine tank of a chlorine generator.

### BACKGROUND OF THE INVENTION

Concentrated Chlorinated Water produced by a Chorine Generator, such as the one taught in U.S. Pat. No. 8,470,143 B2 exits through a chlorine exit tee on the outside of the brine tank of the Chlorine Generator, and is to be delivered to the water being treated. Although the chlorine exit tee is outside brine tank, it is inside the housing of the Chlorine Generator. Concentrated Chlorinated water exits via the chlorine exit tee, and then typically goes to either a venturi suction tube, or through a gravity feeding PVC pipe so as to be delivered to the body of water being treated.

### SUMMARY OF THE INVENTION

The float feeder device makes the Chlorine Generator Unit easier to install, and prevents a pool filter pump from drawing air and losing its prime while the suction created by the filter pump is drawing concentrated chlorinated water.

A general aspect of the invention is a float feeder device for regulating a flow of concentrated chlorinated water from a chlorine generator to water to be treated, the chlorine generator providing concentrated chlorinated water via a chlorine generator exit port. The float feeder device includes: a float housing having a top end and a bottom end; an input port at the top end of the float housing, the input port configured to permit a flow of concentrated chlorinated water into the top end of the float housing from the chlorine generator exit port; a float assembly configured to move up and down within the float housing, the float assembly having a float and an elongated stopper member, the elongated stopper member projecting rigidly downward from a bottom of the float, the elongated stopper member having a stopper end; an output port at the bottom end of the float housing, the output port configured to permit flow of concentrated chlorinated water out from the bottom end of the float housing; and a rubber sealing ring attached at an opening of the output port so as to enable flow of concentrated chlorinated water via the output port only through the rubber sealing ring, the rubber sealing ring configured to receive the stopper end of the elongated stopper member so as to thereby form a fluid-tight and air-tight seal that prevents flow of concentrated chlorinated water and air through the rubber sealing ring whenever the stopper end becomes seated on the rubber sealing ring, thereby ensuring the flow of only concentrated chlorinated water through the output port.

In some embodiments, the input port at the top end of the float housing includes: a short nipple and a male threaded adapter.

In some embodiments, the top end of the float housing includes: a threaded cap and a PVC coupler.

In some embodiments, the float housing includes: a PVC pipe.

In some embodiments, the float is between 6 inches long and 12 inches long.

In some embodiments, the float is configured to move within a distance of half an inch.

In some embodiments, the elongated stopper member includes a guide O-ring affixed towards the stopper end of the elongated stopper member.

In some embodiments, the float feeding device further includes: a guide pipe that extends concentrically upward from the rubber sealing ring and concentrically along the elongated stopper member, the guide pipe cooperating with the guide O-ring to ensure that the stopper end of the elongated stopper member seats concentrically on the rubber sealing ring, thereby forming a fluid-tight seal.

In some embodiments, the rubber sealing ring is a rubber O-ring, and the stopper end is shaped like a cone, the cone configured to concentrically press into the rubber O-ring so as to form a fluid-tight seal.

In some embodiments, the float feeder device further includes: a chlorine exit tube, a first end of the chlorine exit tube connected to and in fluid communication with the output port of the float housing, a second end of the chlorine exit tube also including a fitting for connecting the second end into a hole in a lint pot of a filter pump, the filter pump creating suction that extends through the chlorine exit tube.

In some embodiments, the float housing is made from clear PVC plastic.

In some embodiments, the float feeder device further includes: a housing configured to rest on ground or concrete, and to maintain the float housing in a vertical position, the housing including holes to provide access from outside of the housing to the input port and the output port.

### BRIEF DESCRIPTION OF THE DRAWINGS

The invention will be more fully understood from the following Detailed Description, in conjunction with the following figures, wherein:

FIG. 1A is a perspective view of the float feeder device.

FIG. 1B is a cutaway perspective view of the float feeder device.

FIG. 2 is a side view of the float feeder device.

### DETAILED DESCRIPTION

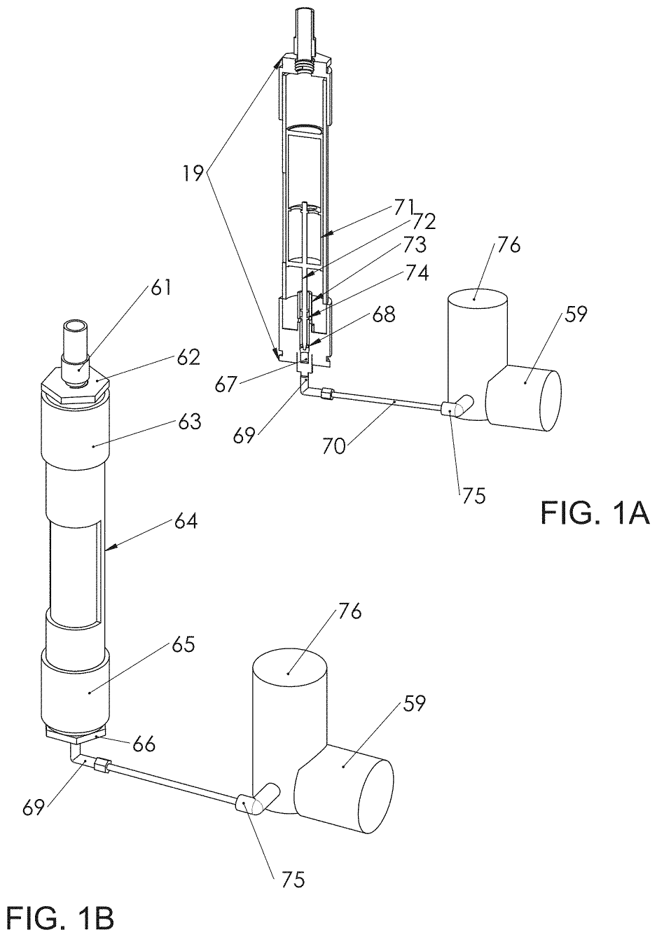

With reference to FIGS. 1A and 1B, the Float Feeder Device 19 will now be discussed. concentrated chlorinated water enters the male adapter 61 of the float feeder device 19. The concentrated chlorinated water exits via a Chlorine Exit Teflon tube 70 that is connected to a Teflon fitting 75 that extends into a hole made in the wall of a lint pot 76, and then is forced by the pool filter pump 59 into to the body of water being treated, such as a swimming pool.

The Float Feeder 19 is attached to the bottom of a chlorine exit ¾″ tee of a chlorine generator by threaded male adapter 61 that is connected to a 2″ bushing 62. The 2″ bushing 62 is connected to PVC coupler 63. A clear PVC float housing 64 is connected to the threaded bottom PVC coupler 65. A 2″ threaded bushing 66 is threaded into the bottom PVC coupler 65. A threaded ½″ inch reducer 67 is threaded into the 2″ threaded bushing 66.

A rubber O-ring 68 is placed in the threaded ½″ inch reducer 67 and a Teflon 90° fitting 69 is threaded into the threaded ½″ inch reducer 67 to deliver the concentrated chlorinated water exiting through the ¼″ Chlorine Exit Teflon tube 70 from the float feeder 19 to a ¼″ Teflon fitting 75 installed into the lint pot 76 of the filter pump 59.

Inside the float feeder 19 is a float 71. Attached to the bottom of the float 71 is a PVC rod 72 extending downward that is machined to a conical point at the end. The PVC rod 72 extends down through a rod guide 73. Teflon O-rings 74 are attached to the PVC rod 72 to keep it aligned within the rod guide 73.

Concentrated Chlorinated water enters the top of the float feeder 19 through threaded ½″ male adapter 61. The concentrated chlorinated water flows around the float 71, and then lifts the float 71 due to buoyancy of the float in the denser concentrated chlorinated water, thereby allowing concentrated chlorinated water to exit the float feeder 19 through the rubber O-ring 68. Then, the concentrated chlorinated water is delivered to the lint pot 76 of the filter pump 59 through ¼″ Chlorine Exit Teflon tubing 70.

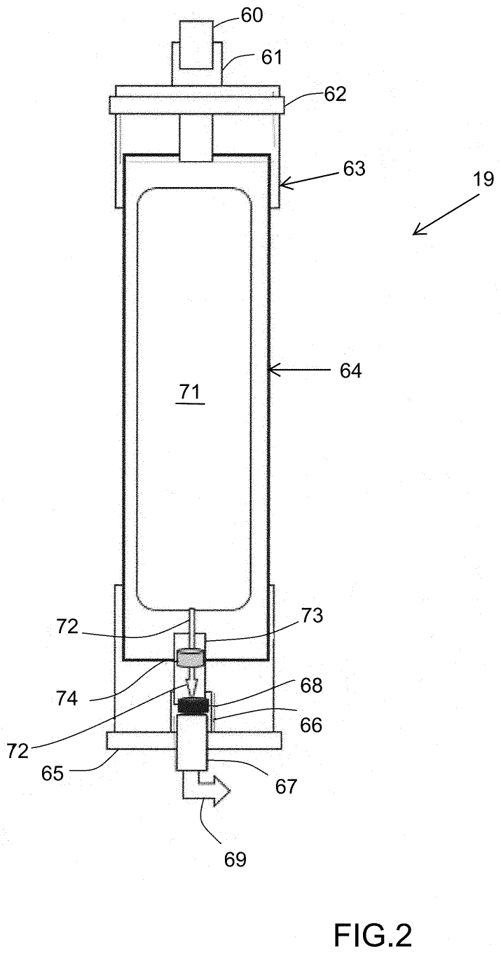

With reference to FIG. 2, when the Chlorine Generator is working, the concentrated chlorine water exiting the brine tank of the Chlorine Generator starts to fill the float feeder 19. Inside the float feeder 19 is a sealed float 71. At the end of the sealed float 71 is a PVC machined rod 72 terminating in a conical point 72′ that is shaped to fit into a Teflon seat 68. A ¼ inch Teflon tube 70 extends from the bottom of the float feeder 19 to the lint pot 76 of the filter pump 59 of pool containing the water to be treated. A ¼ inch plug is removed from the lint pot 76, and a ¼ inch fitting 75 is installed and the Teflon tube 70 is attached. As the concentrated chlorinated water drops into the float feeder 19 and starts to fill the reservoir of the float feeder 19, the conical point 72′ lifts off its seat 68, thereby allowing the concentrated chlorinated water to be drawn by the suction of the lint pot 76 and to be dispensed into the circulating system of the water to be treated. The movement of the float 71 up and down regulates the flow and protects the filter pump 59 from drawing air and losing its prime.

Other modifications and implementations will occur to those skilled in the art without departing from the spirit and the scope of the invention as claimed. Accordingly, the above description is not intended to limit the invention, except as indicated in the following claims.

What is claimed is:

1. A float feeder device for regulating a flow of concentrated chlorinated water from a chlorine generator to water to be treated, the chlorine generator providing concentrated chlorinated water via a chlorine generator exit port, the float feeder device comprising:
a float housing having a top end and a bottom end;
an input port at the top end of the float housing, the input port configured to permit a flow of concentrated chlorinated water into the top end of the float housing from the chlorine generator exit port;
a float assembly configured to move up and down within the float housing, the float assembly having a float and an elongated stopper member, the elongated stopper member projecting rigidly downward from a bottom of the float, the elongated stopper member having a stopper end;
an output port at the bottom end of the float housing, the output port configured to permit flow of concentrated chlorinated water out from the bottom end of the float housing; and
a rubber sealing ring attached at an opening of the output port so as to enable flow of concentrated chlorinated water via the output port only through the rubber sealing ring, the rubber sealing ring configured to receive the stopper end of the elongated stopper member so as to thereby form a fluid-tight and air-tight seal that prevents flow of concentrated chlorinated water and air through the rubber sealing ring whenever the stopper end becomes seated on the rubber sealing ring, thereby ensuring the flow of only concentrated chlorinated water through the output port.

2. The float feeder device of claim 1, wherein the input port at the top end of the float housing includes:
a short nipple and a male threaded adapter.

3. The float feeder device of claim 1, wherein the top end of the float housing includes:
a threaded cap and a PVC coupler.

4. The float feeder device of claim 1, wherein the float housing includes: a PVC pipe.

5. The float feeder device of claim 1, wherein the float is between 6 inches long and 12 inches long.

6. The float feeder device of claim 1, wherein the float is configured to move within a distance of half an inch.

7. The float feeder device of claim 1, wherein the elongated stopper member includes a guide O-ring affixed towards the stopper end of the elongated stopper member.

8. The float feeder device of claim 7, further including:
a guide pipe that extends concentrically upward from the rubber sealing ring and concentrically along the elongated stopper member, the guide pipe cooperating with the guide O-ring to ensure that the stopper end of the elongated stopper member seats concentrically on the rubber sealing ring, thereby forming a fluid-tight seal.

9. The float feeder device of claim 1, wherein the rubber sealing ring is a rubber O-ring, and the stopper end is shaped like a cone, the cone configured to concentrically press into the rubber O-ring so as to form a fluid-tight seal.

10. The float feeder device of claim 1, further comprising:
a chlorine exit tube, a first end of the chlorine exit tube connected to and in fluid communication with the output port of the float housing, a second end of the chlorine exit tube also including a fitting for connecting the second end into a hole in a lint pot of a filter pump, the filter pump creating suction that extends through the chlorine exit tube.

11. The float feeder device of claim 1, wherein the float housing is made from clear PVC plastic.

12. The float feeder device of claim 1, further including a housing configured to rest on ground or concrete, and to maintain the float housing in a vertical position, the housing including holes to provide access from outside of the housing to the input port and the output port.
